(19) United States
(12) Patent Application Publication
(10) Pub. No.: US 2025/0266940 A1
(43) Pub. Date: Aug. 21, 2025

(54) METHOD AND APPARATUS OF BEAM DETERMINATION

(71) Applicant: LENOVO (BEIJING) LIMITED, Beijing (CN)

(72) Inventors: Hongmei Liu, Beijing (CN); Yuantao Zhang, Beijing (CN); Zhi Yan, Beijing (CN); Ruixiang Ma, Beijing (CN); Haiming Wang, Beijing (CN)

(21) Appl. No.: 18/858,470

(22) PCT Filed: Apr. 22, 2022
(86) PCT No.: PCT/CN2022/088515

§ 371 Date: Oct. 21, 2024

(51) Int. Cl. H04L 5/00; H04B 7/06; H04W 72/0446; H04W 72/0453

(52) U.S. Cl. CPC H04L 5/0005; H04B 7/06952; H04L 5/0044; H04W 72/0446; H04W 72/0453

(57) ABSTRACT

Embodiments of the present application are related to a method and apparatus of beam determination. According an embodiment of the present application, an exemplary method includes: receiving information indicating a set of resource in at least one of time domain or frequency domain associated with a set of TCI state, wherein each TCI state of the set of TCI state is associated at least a part of the set of resource, and performing at least one of uplink transmission or downlink reception in the set of resource associated with the set of TCI state.

### TECHNICAL FIELD

Embodiments of the present application generally relate to wireless communication technology, especially to a method and apparatus of beam determination.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In legacy release, to enable transmission and/or reception in a link between a base station (BS), e.g., gNB and a user equipment (UE), the gNB will indicate the UE a downlink (DL) reception or uplink (UL) transmission beam, which may be based on measurement and reporting on reference signals (RS) s to match channel status, e.g., channel state information-reference signal (CSI-RS), synchronization signal (SS)/physical broadcast channel (PBCH) block (SSB), or sounding reference signal (SRS) etc. When there is a repeater between the gNB and the UE, the repeater needs to determine at least one of the reception beam and transmission beam for a link between the gNB and the repeater and determine at least one of the transmission beam and reception beam for a link between the repeater and the UE.

In addition, multiple transmit-receive point (TRP) (also referred to as multi-TRP, or M-TRP) and multiple panels have been introduced into NR since release 16 (Rel-16). For multi-TRP transmission or reception, two or more TRPs at gNB side will be used for DL or UL communication between gNB and UE. For transmission or reception based on multiple panels, two or more panels at UE side will be used for DL or UL communication between gNB and UE. Accordingly, between gNB and repeater, there are multiple links, and different links are associated with different TRPs. However, there is no indication from the gNB to the repeater to indicate the beams associated with each link.

Thus, how to determine RS(s) or beam(s) of a repeater for a time and/or frequency domain resource for the link between the gNB and repeater and the link between the repeater and the UE should be solved.

### SUMMARY OF THE DISCLOSURE

One objective of the present application is to provide a method and apparatus of beam determination, e.g., a method and apparatus of beam determination for links between gNB and repeater, e.g., in multi-TRP/panel transmissions.

According to some embodiments of the present application, an exemplary RAN node e.g., a repeater includes: a transceiver; and a processor coupled to the transceiver, wherein the processor is configured to: receive information indicating a set of resource in at least one of time domain or frequency domain associated with a set of transmission configuration indication (TCI) state, wherein each TCI state of the set of TCI state is associated at least a part of the set of resource, and perform at least one of uplink transmission or downlink reception in the set of resource associated with the set of TCI state.

According to some other embodiments of the present application, an exemplary method, e.g., a method performed in a reporter includes: receiving information indicating a set of resource in at least one of time domain or frequency domain associated with a set of TCI state, wherein each TCI state of the set of TCI state is associated at least a part of the set of resource, and performing at least one of uplink transmission or downlink reception in the set of resource associated with the set of TCI state.

In some embodiments of the present application, the set of resource is a set of slots and each slot in the set of slot is a downlink slot or uplink slot.

In some embodiments of the present application, whether a slot is a downlink slot or uplink slot is determined by a signaling indicating whether at least one symbol in the slot is for downlink or uplink.

In some embodiments of the present application, mapping between the set of TCI state and the set of slots is configured or predefined, and the mapping is cyclic or sequential.

In some embodiments of the present application, a starting position of the set of slot is configured or determined based on reception of a signaling indicating the set of TCI state or a signaling indicating the information.

In some embodiments of the present application, time domain position of the set of slot is configured by a duration in time domain or by a set of slot index.

In some embodiments of the present application, the processor is configured to receive at least one bandwidth part (BWP) configuration for a cell, and each BWP configuration of the at least one BWP configuration comprises a frequency domain starting position, a frequency domain length and subcarrier spacing (SCS) of the corresponding BWP.

In some embodiments of the present application, the set of resource is a set of frequency domain resource divided into a plurality of physical resource block (PRB) groups by a PRB group size, and each PRB group is associated with a TCI state.

In some embodiments of the present application, there are two TCI states, and a PRB group with an even index of the plurality of PRB groups is associated with a first one of the two TCI states and a PRB group with an odd index of the plurality of PRB groups is associated with a second one of the two TCI states.

In some embodiments of the present application, the set of frequency domain resource is a set of frequency domain resource for a cell or a carrier, and a frequency domain starting position of the set of frequency domain resource is at least one of a frequency domain starting position of the cell, a frequency domain starting position of the carrier, a frequency domain starting position of a lowest indexed BWP for the cell or the carrier, or a frequency domain starting position of SSB for the cell or the carrier.

In some embodiments of the present application, the set of frequency domain resource is a set of frequency domain resource for a cell or a carrier, and a frequency domain length of the set of frequency domain resource is determined by bandwidth of the cell or the carrier.

In some embodiments of the present application, the set of frequency domain resource is divided into the plurality of PRB groups within a BWP, and mapping between PRB groups and the set of TCI state is within the BWP.

In some embodiments of the present application, a frequency domain starting position of the set of frequency domain resource in each BWP is a frequency domain starting position of the corresponding BWP, and a frequency domain length of the set of frequency domain resource in each BWP is a bandwidth of the corresponding BWP.

In some embodiments of the present application, the set of resource is associated with the set of TCI state via at least one pair of values, and for each pair of values, a value corresponds to a frequency domain starting position of at least part of the set of frequency domain resource associated with a TCI state of the at least one TCI states and the other value corresponds to a frequency domain length of the at least part of the set of frequency domain resource.

In some embodiments of the present application, there are two TCI states, and for each pair of values, a frequency domain resource index larger than the starting position and smaller than a value equal to the starting position plus a half of the length is associated with a first one of the two TCI states, and a frequency domain resource index larger than the value equal to the starting position plus a half of the length and smaller than a value equal to the starting position plus the length is associated with a second one of the two TCI states.

In some embodiments of the present application, SCS to determine a PRB of a set of resource in frequency domain is configured, based on a frequency band of a cell or a carrier, based on a SSB for a cell or carrier, based on a lowest indexed BWP configuration for a cell or a carrier, or based on SCS of a corresponding BWP associated with the set of resource in frequency domain.

In some embodiments of the present application, the set of resource is a set of resource element (RE) of a demodulation reference signal (DMRS) code division multiplexing (CDM) group, and in the case that there are two DMRS CDM groups and two TCI states, REs corresponding to a first one of the two DMRS CDM groups is associated with a first one of the two TCI states, and REs corresponding to a second one of the two DMRS CDM groups is associated with a second one of the two TCI states.

In some embodiments of the present application, time or frequency position of the REs within a PRB is determined based on a number of additional DMRS, a number of front loaded DMRS symbols, time domain position of the additional DMRS, and a number of DMRS ports.

In some embodiments of the present application, the set of resource is a set of RE of a PTRS port, and in the case that there are two DMRS CDM groups, two TCI states and two PTRS ports, a first one of the two PTRS ports is associated with a first one of the two TCI states and a lowest indexed DMRS port in a first one of the two DMRS CDM groups, and a second one of the two PTRS ports is associated with a second one of the two TCI states and a lowest indexed DMRS port in a second one of the two DMRS CDM groups.

In some embodiments of the present application, time or frequency domain position of REs of each PTRS port are determined based on an associated DMRS port.

In some embodiments of the present application, REs within a resource block (RB) or RBs of each PTRS port are determined by a number of symbol between adjacent PTRS symbols, a number of RBs between adjacent RBs containing PTRS port, a subcarrier level offset with respect to an associated DMRS port.

In some embodiments of the present application, the set of resource is associated with a set of reference signal.

In some embodiments of the present application, the downlink reception is a physical downlink shared channel (PDSCH) and the uplink transmission is a physical uplink shared channel (PUSCH).

Some embodiments of the present application provide another RAN node, e.g., a gNB, which includes: a transceiver; and a processor coupled to the transceiver, wherein the processor is configured to: transmit information indicating a set of resource in at least one of time domain or frequency domain associated with a set of TCI state, wherein each TCI state of the set of TCI state is associated at least a part of the set of resource, and perform uplink reception or downlink transmission in the set of resource associated with the set of TCI state.

Given the above, embodiments of the present application provide a technical solution of beam determination for a RAN node, e.g., a repeater, especially in multi-TRP/panel transmission, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates a schematic diagram of an exemplary wireless communication system in a non-multi-TRP scenario according to some embodiments of the present application.

FIG. 3 illustrates a schematic diagram of an exemplary wireless communication system in a multi-TRP scenario according to some other embodiments of the present application.

FIG. 4 is a flow chart illustrating an exemplary procedure of a method of beam determination according to some embodiments of the present application.

FIG. 5 illustrates a schematic diagram of an association between TCI state and frequency domain resource according to some embodiments of the present application.

FIG. 6 illustrates a schematic diagram of an association between TCI state and frequency domain resource according to some other embodiments of the present application.

FIG. 7 illustrates a schematic diagram of an association between TCI state and time domain resource according to some embodiments of the present application.

FIGS. 8a to 8c illustrate a schematic diagram of an association between TCI state and DMRS CDM group according to some yet other embodiments of the present application respectively.

FIGS. 9a to 9c illustrate a schematic diagram of an association between TCI state and DMRS CDM group according to some yet other embodiments of the present application respectively.

FIGS. 10a to 10c illustrate a schematic diagram of an association between TCI state and DMRS CDM group according to some yet other embodiments of the present application respectively.

FIGS. 11a to 11c illustrate a schematic diagram of an association between TCI state and DMRS CDM group according to some yet other embodiments of the present application respectively.

FIG. 12 illustrates a block diagram of an exemplary apparatus of beam determination according to some embodiments of the present application.

FIG. 13 illustrates a block diagram of an exemplary apparatus of beam determination according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

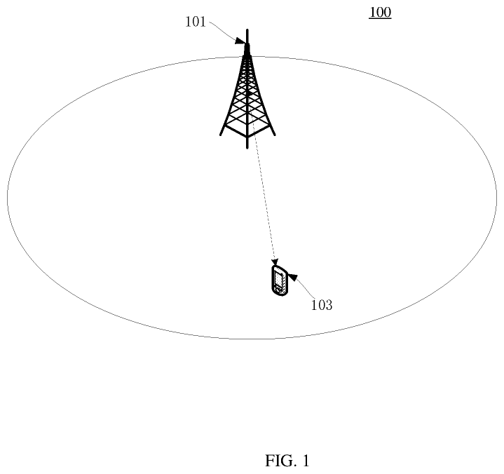

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art. There may be a single panel or multiple panels at the UE side. Different panels can be differentiated by different SRS resource set indexs, TCI states, spatial relation information, etc.

To enhance the coverage area of a BS, relay nodes, such as repeaters may be deployed in a wireless communication system, which can improve the throughput of a mobile device in low signal quality, e.g., a UE that locates in a coverage hole or far from the BS.

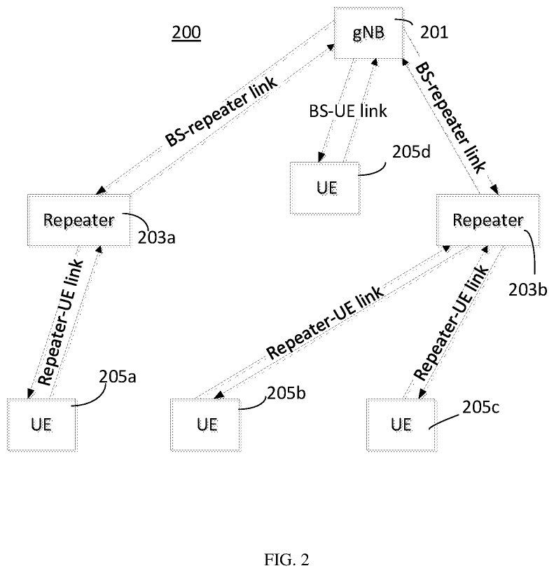

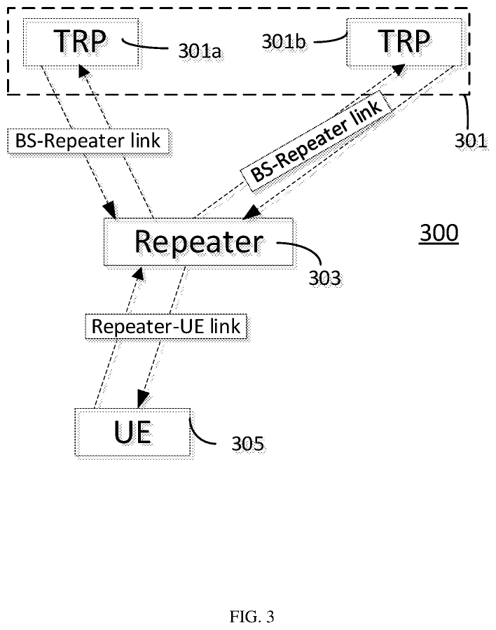

FIG. 2 and FIG. 3 respectively illustrate an exemplary scenario of a wireless communication system with repeaters, wherein FIG. 2 illustrates a schematic diagram of an exemplary wireless communication system 200 in a non-multi-TRP scenario according to some embodiments of the present application, and FIG. 3 illustrates a schematic diagram of an exemplary wireless communication system 300 in a multi-TRP scenario according to some other embodiments of the present application.

Referring to FIG. 2, in the exemplary wireless communication system 200, there are multiple nodes, e.g., a gNB 201, a first repeater 203a, a second repeater 203b, a first UE 205a, a second UE 205b, a third UE 205c and a fourth UE 205d. The gNB 201 may be configured with a single TRP or not. The first repeater 203a is connected with the gNB 201 and the first UE 205a, the second repeater 203b is connected with the gNB 201 and the second UE 205b and the third UE 205c. A link between a BS, e.g., the gNB 201 and a repeater, e.g., the first repeater 203a or the second repeater 203b can be referred to a BS-repeater link (or gNB-repeater link), a link between a repeater, e.g., the first repeater 203a and a UE, e.g., the first UE 205a can be referred to a repeater-UE link; and a link between a BS, e.g., the gNB 201 and a UE, e.g., the fourth UE 205d can be referred to as a BS-UE link (or gNB-UE link).

Persons skilled in the art should well know that each BS, e.g., the gNB 201 can connect with one or more repeaters, e.g., the first repeater 203a and second repeater 203b, and one or more UEs, e.g., the first UE 205a, the second UE 205b, the third UE 205c and the fourth UE 205d; and each repeater, e.g., the first repeater 203a and the second repeater 203b can connect with one or more BSs and one or more UEs. Thus, the exemplary nodes in the wireless communication system 200 with a limited number should not be deemed as the limitation to the present application.

Referring to FIG. 3, in the exemplary wireless communication system 300, there are multiple nodes, e.g., a gNB 301, a repeater 303 and a UE 305, wherein the gNB 301 is configured with (or associated with) two TRPs, e.g., a first TRP 301a and a second TRP 301b. The repeater 303 is connected with each of the first TRP 301a and the second TRP 301b. Thus, there two links between the gNB 301 and the repeater 303, one is a BS-repeater link (or gNB-repeater link, or TRP-repeater link) between the first TRP 301a and the repeater 303 and the other is a BS-repeater link (or gNB-repeater link, or TRP-repeater link) between the second TRP 301b and the repeater 303.

According to RP-213592, smart repeaters, which are transparent to UEs will be studied and identified. The smart repeaters maintain the BS-repeater link and repeater-UE link simultaneously, and need to determine transmission beam and reception beam for BS-repeater link and repeater-UE link (hereafter, referred to as “repeater beam”). However, in some scenarios, e.g., a scenario of multi-TRP transmission, the repeater cannot determine beams for each BS-repeater link associated with different TRPs due to lacking beam indication information from the gNB.

At least to solve the above technical problems, embodiments of the present application propose a technical solution of beam determination, e.g., a method and apparatus of beam determination, so that a RAN node, e.g., a smart repeater can determine beam(s) for multiple BS-repeater links in a scenario of multi-TRP/panel transmission. The beam(s) can be transmission beam(s) or reception beam(s) or both of them, e.g., for PUSCH transmission and PDSCH reception in the repeater and for PUSCH reception and PDSCH transmission in the gNB. Each beam is associated with a set of resource in time and/or frequency domain and at least one RS.

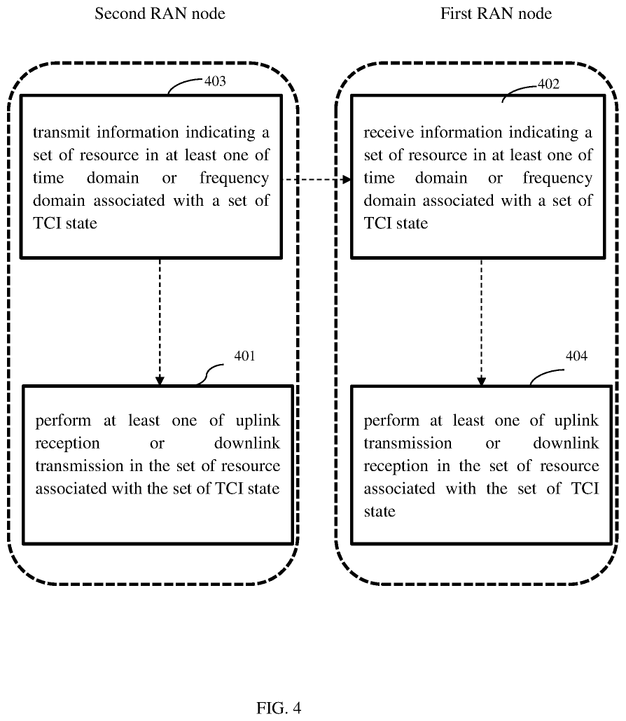

FIG. 4 is a flow chart illustrating an exemplary procedure of a method of beam determination according to some embodiments of the present application. Although the method is illustrated in a system level by a first RAN node, e.g., a repeater and a second RAN node, e.g., a BS, persons skilled in the art should understand that the method implemented in the two RAN nodes can be separately implemented and/or incorporated by other apparatus with the like functions.

Referring to in FIG. 4, the first RAN node, e.g., a repeater is deployed between a second RAN node, e.g., a gNB and a third node, e.g., a UE, and may maintain at least one link between the first RAN node and the second RAN node, e.g., at least one BS-repeater link and at least one link between the first RAN node and the third node, e.g., at least one repeater-UE link simultaneously. The second RAN node will provide necessary side control information, e.g., beamforming information to the first RAN node.

Persons skilled in the art should well know that herein, the wordings, such as the first, the second, and the third etc., are only used to distinguish similar features or elements etc., for clearness, and should not be deemed as limitation to the scope of the technical solutions. In addition, each beam for a RAN node or a node, e.g., a UE is associated with a spatial domain filter for transmission or reception (i.e., a spatial domain transmission or reception filter), which is also associated with at least one RS. For example, each beam or spatial domain filter is associated with at least one of: CSI-RS (or CSI-RS resource), or SSB, or SRS (or SRS resource), or TCI state, or joint TCI state, or spatial relation information etc. Each TCI state, or spatial relation information, or joint TCI state for at least one of downlink and uplink may be associated with one or two quasi co-located (QCL)-typeD RSs.

In an exemplary scenario of multi-TRP transmission, there are two or more links between the first RAN node and the second RAN node, e.g., two or more BS-repeater links simultaneously and one link between the first RAN node and the third node, e.g., one repeater-UE link. Different BS-repeater links are associated with different TRPs, so that the beam or RS indication from the gNB to the repeater will be associated with different resources in at least one time domain or frequency domain (also referred to as time and/or frequency resource).

According to multi-TRP in Rel-16 and Rel-17, there are multiple schemes, e.g., scheme(s) based on single frequency network (SFN), scheme(s) based on time domain multiplexing (TDM), schemes based on spatial domain multiplexing (SDM) and scheme(s) based on frequency domain multiplexing (FDM).

Regarding scheme(s) based on SFN, it includes sfnSchemeA and sfnSchemeB. There are two TCI states and two DMRS CDM groups for resources in at least one of time domain or frequency domain in sfnSchemeA and sfnSchemeB. The first TCI state of the two TCI states is associated with the first one of the two DMRS CDM groups and the second TCI state of the two TCI states is associated with the second one of the two DMRS CDM groups.

Regarding scheme(s) based on TDM, it includes tdmSchemeA. There are two TCI states and one DMRS CDM group in tdmSchemeA. All time-frequency resources adopt the same DMRS CDM group, while different time resources are associated with different TCI states.

Regarding scheme(s) based on FDM, it includes fdmSchemeA and fdmSChemeB. There are two TCI states and one DMRS CDM group FDM. All time-frequency resources adopt the same DMRS CDM group, while different frequency resources are associated with different TCI states.

The second node, e.g., the gNB may configure (or determine) information indicating a set of resource in at least one of time domain or frequency domain associated with a set of TCI state, and transmit the information to the first node in step 401. Accordingly, the first RAN node, e.g., the repeater will receive the information indicating the set of resource in step 402. The information can be transmitted via system information block (SIB), RRC, MAC CE or DCI (e.g., group common DCI). Herein, the wording “a set of” means “one or more” and “at least one” or the like.

The second node, e.g., the gNB may also configure at least one BWP configuration for a cell and indicate the at least one BWP configuration to the first RAN node. Each BWP configuration of the at least one BWP configuration includes a frequency domain starting position, a frequency domain length and SCS of the corresponding BWP.

A resource in at least one of time or frequency domain may be a time domain resource (time resource), a frequency domain resource (frequency resource) or a time and frequency domain resource (time-frequency resource). In addition, dependent on different schemes for multi-TRP, a resource in at least one of time or frequency domain can be represented in various manners. In a scenario of multi-panel, different panels are associated with different resource sets. A time or frequency resource in each resource set can be associated with a set of RS, e.g., a set of SSB, a set of CSI-RS, or a set of SRS etc.

For example, according to some embodiments of the present application, the set of resource includes or is one or more time domain resources. In some exemplary scenarios, e.g., in multi-TRP transmission adopting tdmSchemeA, the set of resource is a set of slots and each slot in the set of slot is a downlink slot or uplink slot. Whether a slot is a downlink slot or uplink slot is determined by a signaling indicating whether at least one symbol in the slot is for downlink or uplink. Mapping between the set of TCI state and the set of slots is configured or predefined. The mapping is cyclic or sequential. For cyclic mapping, when there are two TCI states and 4 slots, the first TCI state is associated with the first and the third slot, and the second TCI state is associated with the second and the fourth slot. For sequential mapping, when there are two TCI states and 4 slots, the first TCI state is associated with the first and the second slot, and the second TCI state is associated with the third and the fourth slot. A starting position of the set of slot is configured or determined based on reception of a signaling indicating the set of TCI state or a signaling indicating the set of resource. The time domain position of the set of slot is configured by a duration in time domain or by a set of slot index.

According to some other embodiments of the present application of the present application, the set of resource includes or is one or more frequency domain resources.

In some exemplary scenarios, e.g., in multi-TRP transmission adopting fdmSchemeA and fdmSchemeB, the set of resource is a set of frequency domain resource divided into a plurality of PRB groups by a PRB group (PRG) size, and each PRB group is associated with a TCI state according to some embodiments of the present application. For example, there are two TCI states, and a PRB group with an even index (indexing from zero) of the plurality of PRB groups is associated with a first one of the two TCI states and a PRB group with an odd index of the plurality of PRB groups is associated with a second one of the two TCI states.

The set of frequency domain resource may be configured for a cell or a carrier. The frequency domain starting position of the set of frequency domain resource is at least one of a frequency domain starting position of the cell, a frequency domain starting position of the carrier, a frequency domain starting position of a lowest indexed BWP for the cell or the carrier, or a frequency domain starting position of SSB for the cell or the carrier. The frequency domain length of the set of frequency domain resource is determined by a BWP of the cell or the carrier. The frequency domain length of the set of frequency domain resource can also be determined by the frequency domain length of the cell or the carrier, or the frequency domain length of the set of frequency domain resource can also be configured by gNB.

In some other embodiments of the present application, the set of frequency domain resource is divided into a plurality of PRB groups within a BWP, and the mapping between PRB groups and the set of TCI state is within the BWP. The frequency domain starting position of the set of frequency domain resource in each BWP is a frequency domain starting position of the corresponding BWP. The frequency domain length of the set of frequency domain resource in each BWP is a bandwidth of the corresponding BWP.

In some exemplary scenarios, e.g., also in multi-TRP transmission adopting fdmSchemeA and fdmSchemeB, the set of resource is associated with the set of TCI state via at least one pair of values. For each pair of values, one value corresponds to a frequency domain starting position of at least part of the set of frequency domain resource associated with a TCI state of the at least one TCI states, and the other value corresponds to a frequency domain length of the at least part of the set of frequency domain resource. In the case that there are two TCI states, for each pair of values, the lower half of the frequency domain resource (i.e., a frequency domain resource index larger than the starting position and smaller than a value equal to the starting position plus a half of the length) is associated with a first one of the two TCI states, and the higher half of the frequency domain resource (i.e., a frequency domain resource index larger than the value equal to the starting position plus a half of the length and smaller than a value equal to the starting position plus the length) is associated with a second one of the two TCI states.

According to some yet other embodiments of the present application of the present application, the set of resource includes or is one or more spatial domain resources (spatial resources).

In some exemplary scenarios, e.g., in multi-TRP transmission adopting sfnSchemeA and sfnSchemeB, the set of resource is a set of RE of a DMRS CDM group or a set of RE of a PTRS port.

In the case that there are two DMRS CDM groups and two TCI states, REs corresponding to the first one of the two DMRS CDM groups is associated with the first one of the two TCI states, and REs corresponding to the second one of the two DMRS CDM groups is associated with the second one of the two TCI states. In the case that there are two DMRS CDM groups, two TCI states and two PTRS ports, the first one of the two PTRS ports is associated with the first one of the two TCI states and the lowest indexed DMRS port in the first one of the two DMRS CDM groups, and the second one of the two PTRS ports is associated with the second one of the two TCI states and the lowest indexed DMRS port in the second one of the two DMRS CDM groups.

The time or frequency position of the REs within a PRB can be determined based on a number of additional DMRS, a number of front loaded DMRS symbols, time domain position of the additional DMRS, and a number of DMRS ports. In addition, the time or frequency domain position of REs of each PTRS port are determined based on an associated DMRS port. REs within a RB or RBs of each PTRS port are determined by a number of symbol between adjacent PTRS symbols, a number of RBs between adjacent RBs containing PTRS port, and a subcarrier level offset with respect to subcarrier of an associated DMRS port.

In addition, when the set of resource include time or frequency domain resource, for a PRB of a set of resource in frequency domain or for a slot of a set of time domain resource, the SCS to determine the size of PRB or the size of the slot is also configured for the first RAN node by the second RN node. The SCS can also be based on a frequency band of a cell or a carrier, based on SSB for a cell or carrier, based on a lowest indexed BWP configuration for a cell or a carrier, or based on SCS of a corresponding BWP associated with the set of resource in frequency domain.

Based on the information, beam sweeping will be performed for links between the first RAN node and the second RAN node, that is, all repeater beams associated with different TRPs will be determined in the first node and second node with different beam directions. Each beam can be associated with one or two RSs or associated with a resource in at least one of time domain or frequency domain. Accordingly, in step 403, the second RAN node, e.g., the gNB will perform uplink reception e.g., PUSCH and PUCCH, or downlink transmission, e.g., PDCCH and PDSCH in the set of resource associated with the set of TCI state. In step 404, the first RAN node will perform uplink transmission, e.g., PUSCH and PUCCH, or downlink transmission in the set of resource associated with the set of TCI state.

Taking a repeater as an example of the first RAN node, and taking a gNB as an example of the second RAN node, more details on how to determine beams for BS-repeater links in the scenario of multi-TRP/panel transmission will be illustrated below in view of various exemplary embodiments of the present application.

In exemplary multi-TRP/panel transmission, the gNB indicates to the repeater two TCI states or two RSs, and each TCI state is associated with a set of time and/or frequency domain resources. The two TCI states may be associated with different spatial domain reception filters (i.e., beams), or different reception panels (e.g., RSs or RS sets) at the repeater side. The gNB will indicate to the repeater the association (or mapping) between TCI states and resources in at least one of time domain or frequency domain (hereafter, also referred to as time/frequency domain resource).

Firstly, in frequency domain, according to Rel-16 and Rel-17, for fdmSchemeA and fdmSchemeB, frequency domain resources allocated to a single UE are divided into two parts. There are two types of division depending on the PRB bundling size to be wideband or 2/4 PRB (i.e., 2 or 4 PPBs). For the repeater, the frequency domain resource division from the perspective of cell or carrier will consider resource allocation of multiple UEs in the cell.

When the PRB bundling size is wideband in a cell or a carrier, for a specific UE, continuous PRBs allocated to the UE will be divided into two parts, e.g., in the middle of the PRBs. Different parts of PRBs will be associated with different TCI states. Since there may be multiple UEs in the cell, the gNB may indicate multiple pairs of starting position and length of PRBs for UEs to the repeater.

For example, in some embodiments of the present application, to indicate the frequency domain resource associated with each TCI state, there will be indication from the gNB to the repeater indicating at least one pair of starting position and length. The SCS to determine the size of the length can be explicitly configured or implicitly determined based on the frequency band, SCS of the lowest indexed BWP, e.g., BWP #0, or SCS of an initial downlink BWP, which may be identical with the lowest indexed BWP. The starting position can be determined based on the lowest indexed PRB of the cell, the lowest indexed PRB of the carrier or the lowest indexed PRB of SSB etc. Based on each pair of the starting position (represented by “S”) and length (represented by “L”), the PRBs within the range (S+L/2) are associated with the first TCI state, and the others are associated with the second TCI state.

In some other embodiments of the present application, the gNB can also indicate to the repeater a set of BWP configurations, each BWP is associated with a starting position, a length and a SCS. Multiple pairs of starting and length can be configured for a BWP from the gNB to the repeater. Similarly, based on each pair of the starting position (represented by “S”) and length (represented by “L”), the PRBs within the range (S+L/2) are associated with the first TCI state, and the others are associated with the second TCI state.

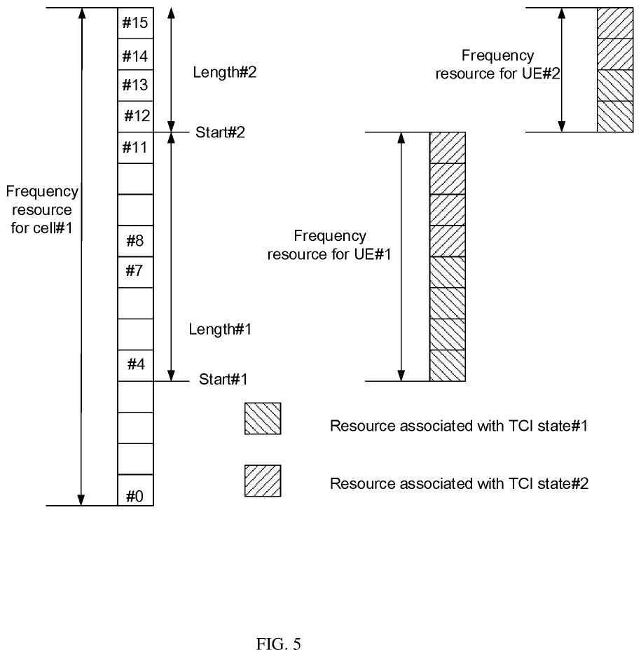

FIG. 5 illustrates a schematic diagram of an association between TCI state and frequency domain resource according to some embodiments of the present application.

Referring to FIG. 5, the PRB bundling size is wideband in a cell, e.g., cell #1. There are multiple UEs, e.g., UE #1 and UE #2. In addition, two TCI states, e.g., TCI state #1 and TCI state #2 are configured in the cell. A pair of starting position and length, e.g., start #1 and length #1 is configured to UE #1, wherein start #is 4 and length is 8. Thus, for UE #1, PRB #4 to PRB #7 are associated with TCI state #1 while PRB #8 to PRB #11 are associated with TCI state #2. Another pair of staring position and length, e.g., start #2 and length #2 is configured to UE #2, wherein start #2 is 12 and the length is 4. Thus, for UE #2, PRB #12 to PRB #13 are associated with TCI state #1 while PRB #14 to PRB #15 are associated with TCI state #2.

When the PRB bundling size is 2 or 4, the PRBs of a cell or a carrier are divided into multiple PRB groups. The size of each PRG can be configured to be 2 or 4. Even (indexing from zero) PRGs are associated with the first TCI state for a gNB-repeater link, and odd PRGs are associated with the second TCI state for another gNB-repeater link. The starting position for dividing the PRGs can be explicitly configured or implicitly determined to be the starting position of the cell or the starting position of the carrier. The SCS for PRG division can also be explicitly configured or implicitly determined based on the frequency band, or SCS of BWP #0 etc.

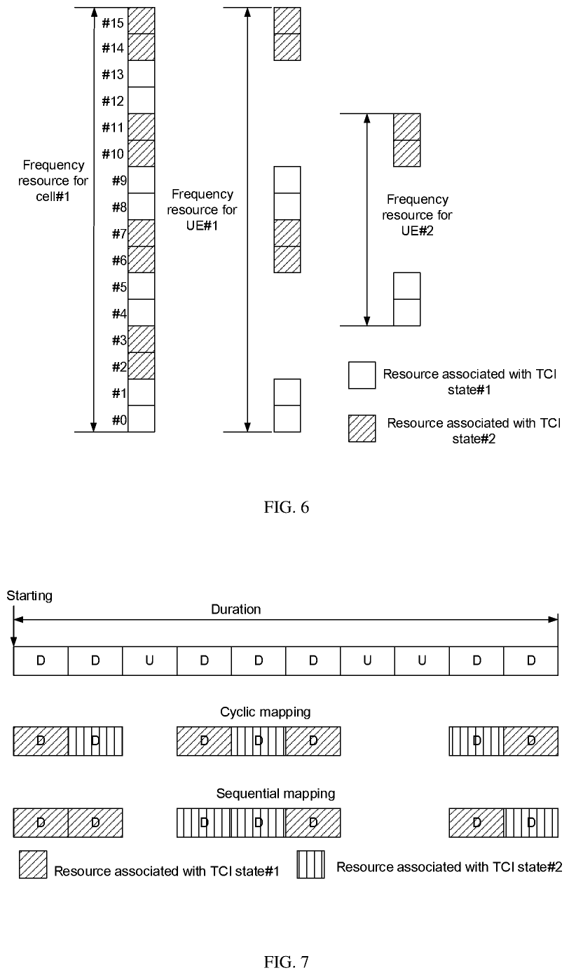

Since the PRG division is from the cell perspective, there may be some scheduling restrictions for UE to keep UE understanding the same as in legacy technology. For example, the starting PRB group configured to a UE will be a PRB group associated with the first state, e.g., TCI state #1 in the cell specific configuration. For example, for UE #2, the starting PRB group index can only be the even PRB index (e.g., #0, #2, #4, etc.) If the resource allocated to a UE is not continuous PRB group, the gap between adjacent PRB groups will be twice of the PRB group (i.e. 4 PRBs in FIG. 6)

In addition, multiple BWP configurations can also be transmitted from the gNB to the repeater. Each BWP is associated with a starting position, a length and a SCS. The PRG size can be configured for each BWP. That is, the PRG division is performed within each BWP. Association between PRG and TCI state is performed for each BWP. For example, even PRG indexs within a BWP are associated with the first TCI state of two TCI states, and odd PRG indexs within the BWP are associated with the second TCI state within the BWP.

FIG. 6 illustrates a schematic diagram of an association between TCI state and frequency domain resource according to some other embodiments of the present application.

Referring to FIG. 6, the PRB bundling size is 2 in a cell, e.g., cell #1. There are multiple UEs, e.g., UE #1 and UE #2. Each two PRBs are grouped into a PRG. The PRG can be indexed as PRG #0, PRG #1, PRG #2, etc. PRG #0 is corresponding to PRB #0 and PRB #1, PRG #1 is corresponding to PRB #2 and PRB #3, and PRB #2 is corresponding to PRB #4 and PRB #5, etc. One or more PRGs can be allocated to a UE. For example, UE #1 is allocated with PRG #0, PRG #3, PRG #4, and PRG #7, and the corresponding PRB index are PRB #0, #1, #6, #7, #8, #9, #14, #15. For UE #2, it is allocated with PRG #2, PRG #5, and the corresponding PRB index are PRB #4, #5, #10, #11. In addition, two TCI states, e.g., TCI state #1 and TCI state #2 are configured in the cell. Thus, if a PRG configured for a UE, e.g., UE #1 or UE #2 is an even PRG, then it will be associated with TCI state #1; and if a PRG configured for the same UE is also odd PRG, then it will be associated with TCI state #2. For example, PRG #0. #6, #8, #14 allocated to UE #1 is associated with TCI state #1, and PRG #1, #7, #9, #15 allocated to UE #1 is associated with TCI state #2.

In time domain, the gNB may indicate to the repeater a time division duplexing (TDD) configuration pattern in some embodiments of the present application. The repeater can determine which time domain resource is a downlink slot or a uplink slot, e.g., downlink slot for PDSCH or uplink slot for PUSCH.

For example, the gNB indicates to the repeater two TCI states, e.g., by a DCI or a MAC CE and a duration. Within the duration, the repeater can determine the slots, which may be uplink slots or downlink slots. The two TCI states can be mapped to slots in a cyclic mapping pattern or a sequential mapping pattern.

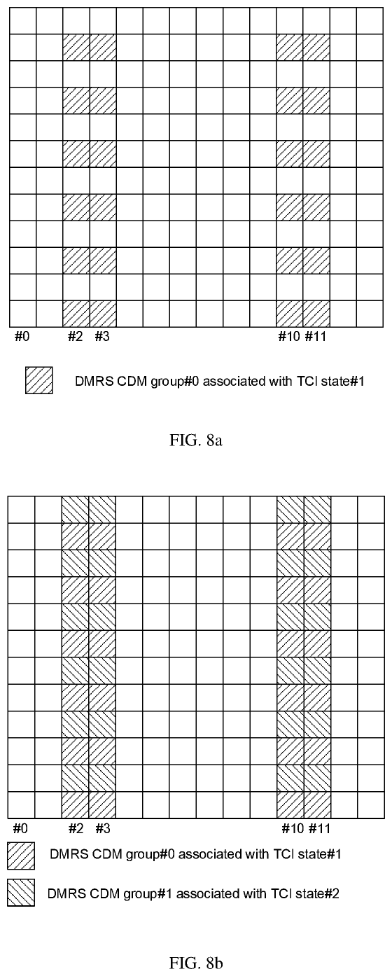

FIG. 7 illustrates a schematic diagram of an association between TCI state and time domain resource according to some embodiments of the present application.

Referring to FIG. 7, the gNB indicates to the repeater two TCI states, e.g., TCI state #1 and TCI state #2 and a duration in time domain. Within the duration, there are a plurality of uplink slots (represented by “U”) and downlink slots (represented by “D”). The repeater can determine the association between the TCI states and downlink slots or uplink slots within the duration. Taking downlink slots as an example, according to the cyclic mapping pattern, within the duration, the first TCI state is associated with the even (indexing from zero) downlink slots, and the second TCI state is associated with downlink slots. While, according to the sequential mapping pattern within the duration, the first and the second downlink slots are associated with the first TCI state, the third and the fourth downlink slots are associated with the second TCI state, and so on. The TCI state indication can be applied to downlink slots only.

The TCI state indication can also be applied to uplink slots only. In this case, with cyclic mapping, the even indexed uplink slot will be associated with TCI state #1, and the odd indexed uplink slot will be associated with TCI state #2. With sequential mapping, the 1^{st} and the 2^{nd} uplink slots will be associated with TCI state #1, and the 3^{rd} and 4^{th} uplink slots will be associated with TCI state #2.

The TCI state can also be applied to both downlink slots and uplink slots. In this case, with cyclic mapping, the even indexed slot (no matter it is downlink or uplink) will be associated with TCI #1, and the odd indexed slot will be associated with TCI state #2. With sequential mapping, the 1^{st} and the 2^{nd} slot will be associated with TCI state #1, and the 3^{rd} and 4^{th} slot will be associated with TCI state #2.

In spatial domain, according to Rel-16 and Rel-17, when there are two TCI states and one DMRS CDM group, different time/frequency domain resources are associated with different TCI states and the same DMRS CDM group, and the PTRS port of each DMRS CDM group is associated with the lowest indexed DMRS port of the DMRS CDM group. When there are two TCI states and two DMRS CDM groups, for sfnSchemeA and sfnSchemeB, the first TCI state is associated with the first DMRS CDM group, and the second TCI state is associated with the second DMRS CDM group. Both the first TCI state and the first DMRS CDM group are associated with a first set of time/frequency domain resources, and the second TCI state and the second DMRS CDM group are associated with a second set of time/frequency domain resources.

The DMRS CDM group is also configured per UE in legacy release. However, for gNB-repeater link, a cell specific DMRS configuration or PTRS port configuration is considered in some embodiments of the present application, so that the repeater can determine the corresponding spatial domain reception filter (beam) and/or panel for a DMRS CDM group, or time/frequency domain resource associated with the DMRS CDM group or PTRS port.

For example, a cell specific DMRS pattern can be configured or predefined according to some embodiments of the present application. The cell specific DMRS pattern information may include DMRS configuration information, e.g., type 1 or type 2, additional DMRS configuration, e.g., value=2, the number of frontloaded DMRS e.g., number=2. Based on the above configuration information, REs for a DMRS CDM group within a PRB can be determined.

In addition, the number of TCI states, e.g., 1 or 2 or more is configured from the gNB to the repeater, while the number of DMRS CDM group, e.g., 1 or 2 or more is configured from the gNB to the UE. The number of DMRS CDM groups is also configured from gNB to repeater. The association between TCI state and DMRS CDM group can be determined based on the corresponding numbers at the repeater side, and the spatial domain reception filter (or panel) at the repeater side for different REs can also be determined accordingly.

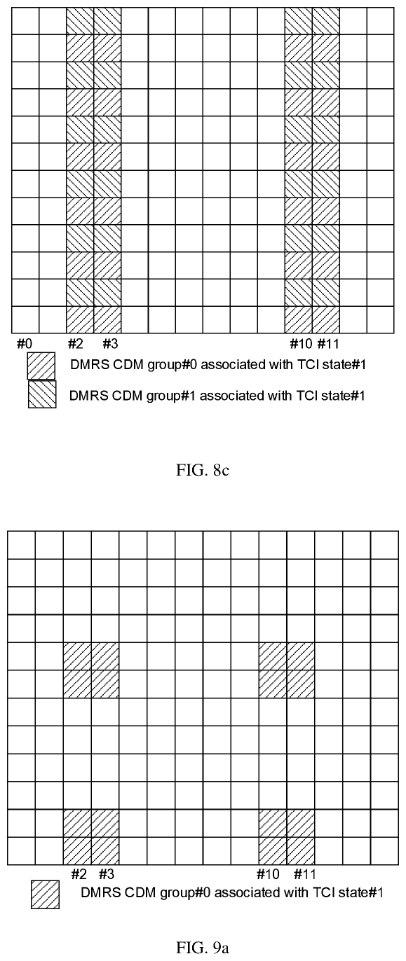

FIGS. 8a to 8c illustrate a schematic diagram of an association between TCI state and DMRS CDM group according to some embodiments of the present application respectively.

Referring to FIGS. 8a to 8c, DMRS configuration type 1 is indicated by the gNB. The number of front loaded DMRS symbols is 2, so there are 2 continuous symbols occupied by DMRS. There is an additional DMRS, and the time domain position of additional DMRS is in symbol #10 (indexed from 0). So symbol #10 and symbol #11 are carrying additional DMRS. Regarding the time domain position of front-loaded DMRS which is located in symbol #2 and symbol #3, it is also determined based on a configuration. For DMRS configuration 1, the even subcarrier within a PRB is associated with DMRS CDM group #0, and the odd subcarrier within a PRB is associated with DMRS CDM group #1. The association between DMRS groups and TCI states is determined based on the number of TCI states and the number of DMRS CDM groups. In FIG. 8a, there is one DMRS CDM group, e.g., DMRS CDM group #0 and one TCI state, e.g., TCI state #1. DMRS CDM group #0 is associated with TCI state #1. In FIG. 8b, there are two DMRS CDM groups, e.g., DMRS CDM group #0, DMRS CDM group #1 and two TCI states, e.g., TCI state #1, TCI state #2. DMRS CDM group #0 is associated with TCI state #1, and DMRS CDM group #1 is associated with TCI state #2. In FIG. 8c, there are two DMRS CDM groups, e.g., DMRS CDM group #0, DMRS CDM group #1 and one TCI states, e.g., TCI state #1. Both DMRS CDM group #0 and DMRS CDM group #1 are associated with TCI state #1. Based on the association between DMRS CDM group and TCI states, the repeater can determine that the RE corresponding to different DMRS CDM groups are associated with different TCI states. So at different REs corresponding to different DMRS CDM groups, different beams for gNB-repeater link and repeater-UE link can be determined based on the associated TCI state.

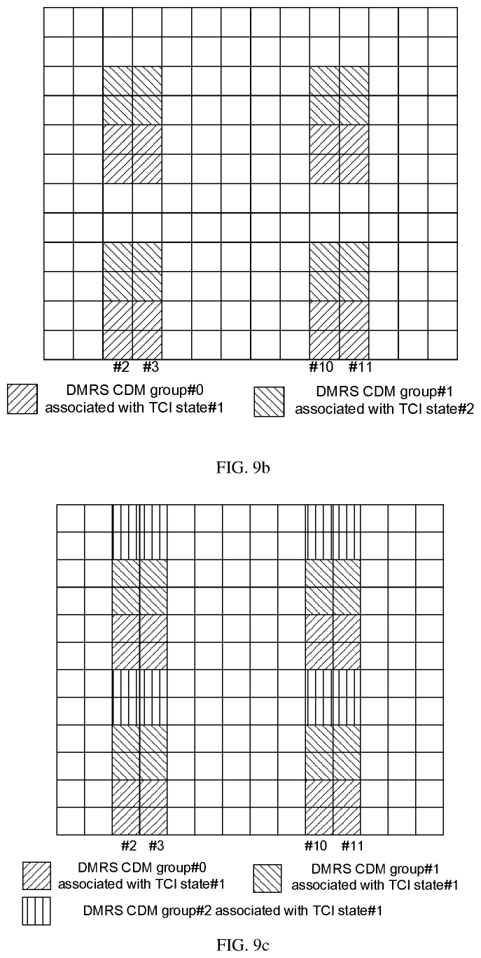

FIGS. 9a to 9c illustrate a schematic diagram of an association between TCI state and DMRS CDM group according to some other embodiments of the present application respectively.

Referring to FIGS. 9a to 9c, the DMRS configuration type 2 is indicated by the gNB. The number of front loaded DMRS symbols is 2, so there are 2 continuous symbols occupied by DMRS. There is an additional DMRS, and the time domain position of additional DMRS is in symbol #10 (indexed from 0). So symbol #10 and symbol #11 are carrying additional DMRS. Regarding the time domain position of front-loaded DMRS which is located in symbol #2 and symbol #3, it is also determined based on a configuration. For DMRS configuration 2, subcarrier #0, #1, #6. #7 (indexed from 0) within a PRB is associated with DMRS CDM group #0, and subcarrier #2, #3, #8, #9 (indexed from 0) within a PRB is associated with DMRS CDM group #1, subcarrier #4, #5, #10, #11 within a PRB is associated with DMRS CDM group #2. The association between DMRS groups and TCI states is determined based on the number of TCI states and the number of DMRS CDM groups. In FIG. 9a, there is one DMRS CDM group, e.g., DMRS CDM group #0 and one TCI state, e.g., TCI state #1. DMRS CDM group #0 is associated with TCI state #1. In FIG. 9b, there are two DMRS CDM groups, e.g., DMRS CDM group #0, DMRS CDM group #1 and two TCI states, e.g., TCI state #1, TCI state #2. DMRS CDM group #0 is associated with TCI state #1, and DMRS CDM group #1 is associated with TCI state #2. In FIG. 9c, there are three DMRS CDM groups, e.g., DMRS CDM group #0, DMRS CDM group #1, DMRS CDM group #2 and one TCI states, e.g., TCI state #1. All the three DMRS CDM groups are associated with TCI state #1. Based on the association between DMRS CDM group and TCI states, the repeater can determine that the RE corresponding to different DMRS CDM groups are associated with different TCI states. So at different REs corresponding to different DMRS CDM groups, different beams for gNB-repeater link and repeater-UE link can be determined based on the associated TCI state.

Similarly, for PTRS port, a cell specific time/frequency domain density will be configured or predefined according to some embodiments of the present application. For example, the number of symbols, e.g., 2 between two adjacent PTRS ports or DMRS symbols, and the number of PRBs containing PTRS RE, e.g., 2 can be configured or predefined. A RE level offset or RB level offset can also be configured or predefined for different DMRS ports, which can be the same as “offset00.”

The association between PTRS port and TCI state is determined based on the number of PTRS ports, number of DMRS CDM groups, and number of TCI states. The association between DMRS CDM group and TCI states is the same as that described for FIGS. 8a to 9c. The PTRS port to DMRS CDM group association is additionally based on the number of PTRS ports and the number of DMRS CDM groups. When there is one TCI state and 1 PTRS port regardless of 1 or 2 DMRS CDM groups, the PTRS RE position and spatial domain filter is associated with the lowest indexed DMRS port, e.g., DMRS port #0. When there are one TCI state and 2 DMRS CDM groups, and two PTRS ports, RE position and spatial domain filter for each PTRS are associated with the lowest DMRS port within each DMRS CDM group, that is, spatial domain filter for both two PTRS ports are associated with the only one TCI state, and the RE position for PTRS #0 is based on the lowest DMRS port within DMRS CDM group #0, and the RE position for PTRS #1 is based on the lowest DMRS port within DMRS CDM group #1.

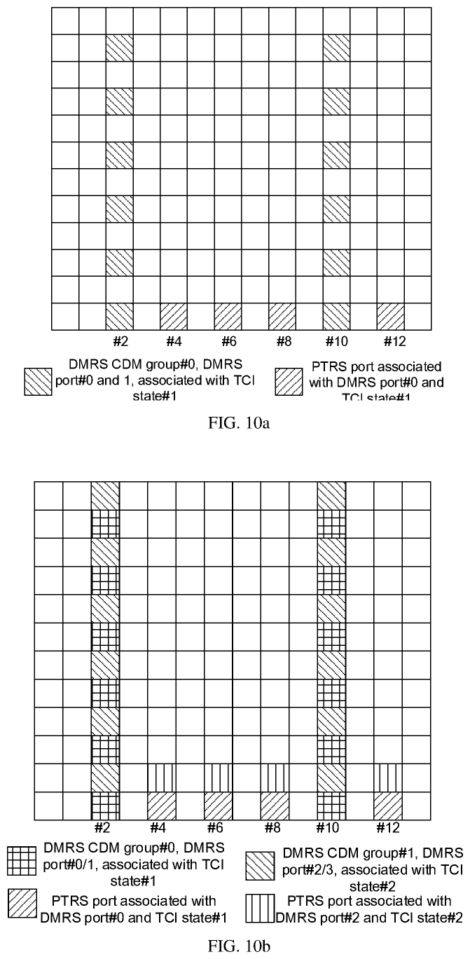

FIGS. 10a to 10c illustrate a schematic diagram of an association between TCI state, DMRS CDM group and PTRS port according to some yet other embodiments of the present application respectively.

Referring to FIGS. 10a to 10c, DMRS configuration type 1 is indicated by the gNB. The number of front loaded DMRS symbols is 1, so there is 1 symbol occupied by DMRS. There is an additional DMRS, and the time domain position of additional DMRS is in symbol #10 (indexed from 0). So symbol #10 is carrying additional DMRS. Regarding the time domain position of front-loaded DMRS which is located in symbol #2, it is also determined based on a configuration. For DMRS configuration 1, the even subcarrier within a PRB is associated with DMRS CDM group #0, and the odd subcarrier within a PRB is associated with DMRS CDM group #1. As there is only 1 symbol for front-loaded DMRS, only DMRS port #0-3 can be configured. DMRS CDM group #0 contains DMRS port #0 and #1, and DMRS CDM group #1 contains DMRS port #2 and #3. For PTRS configuration, as the time domain density is 2, so the PTRS port is located at symbol #4, #6, #8, #12. In FIG. 10a, the PTRS port is associated with DMRS port #0, so the subcarrier of PTRS port is 0 (indexed from 0). In FIG. 10b, there are two DMRS CDM groups. DMRS CDM group #0 occupies even subcarriers, and DMRS CDM group #1 occupies odd subcarriers. There are two PTRS ports (indexed from 0), the time domain location for both PTRS ports are identical. The frequency domain position of the first PTRS port (hereafter, PTRS port #0) is determined by the associated DMRS port #0, so the frequency domain position of the firsts PTRS port is the first subcarrier (hereafter, subcarrier #0). The frequency domain position of PTRS #1 is determined by the associated DMRS port #2, so the frequency domain position of the second PTRS port (hereafter, PTRS port #1) is the second subcarrier (hereafter, subcarrier #1). FIG. 10c is similar to FIG. 10b, while there is only one PTRS port.

In FIG. 10a, there is one DMRS CDM group, e.g., DMRS CDM group #0 and one TCI state, e.g., TCI state #1. Both DMRS port #0 and DMRS port #1 of DMRS CDM group #0 are associated with TCI state #1. There is a single PTRS port #0, and it is associated with DMRS port #0, and it is also associated with TCI state #1. In FIG. 10b, there are two DMRS CDM groups, e.g., DMRS CDM group #0, DMRS CDM group #1 and two TCI states, e.g., TCI state #1, TCI state #2. Besides DMRS port #0 and DMRS #1 of DMRS CDM group #0 are associated with TCI state #1. There are two PTRS ports, PTRS port #0 and PTRS port #1. PTRS port #0 is associated with DMRS port #0, and it is also associated with TCI state #1. DMRS port #2 and DMRS port #3 of DMRS CDM group #1 are associated with TCI state #2. PTRS port #1 is associated with DMRS port #2, and it is also associated with TCI state #2. In FIG. 10c, there are two DMRS CDM groups, e.g., DMRS CDM group #0, DMRS CDM group #1 and two TCI states, e.g., TCI state #1, TCI state #2, and one PTRS port, i.e., PTRS port #0. Both DMRS port #0 and DMRS port #1 of DMRS CDM group #0 are associated with TCI state #1. DMRS port #2 and DMRS port #3 of DMRS CDM group #1 are associated with TCI state #2. There is only one PTRS port, and PTRS port #0 is associated with the lowest indexed DMRS port among two DMRS CDM groups, i.e., DMRS port #0, and PTRS port #0 are also associated with TCI state #1.

Based on the association between PTRS port and TCI state, the spatial domain filter for the RE corresponding to each PTRS can also be determined.

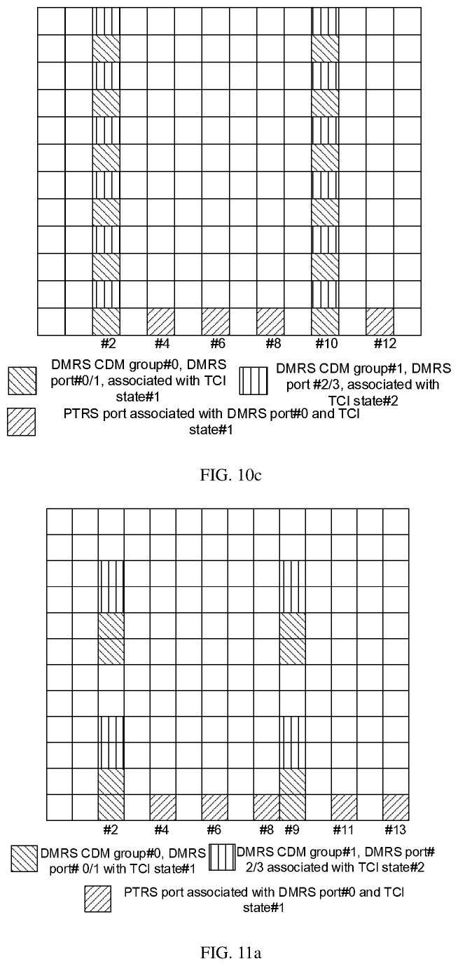

FIGS. 11a to 11c illustrate a schematic diagram of an association between TCI state and DMRS CDM group according to some yet other embodiments of the present application respectively.

Referring to FIGS. 11a to 11c, the DMRS configuration type 2 is indicated by the gNB. The number of front loaded DMRS symbols is 1, so there is 1 symbol occupied by DMRS. There is an additional DMRS, and the time domain position of additional DMRS is in symbol #10 (indexed from 0). So symbol #10 is carrying additional DMRS. Regarding the time domain position of front-loaded DMRS which is located in symbol #2, it is also determined based on a configuration. For DMRS configuration 2, subcarrier #0. #1. #6, #7 (indexed from 0) within a PRB is associated with DMRS CDM group #0, and subcarrier #2, #3. #8, #9 (indexed from 0) within a PRB is associated with DMRS CDM group #1, subcarrier #4, #5, #10, #11 within a PRB is associated with DMRS CDM group #2. As there is only one symbol for front-loaded DMRS, only DMRS port #0-5 can be configured. DMRS CDM group #0 contains DMRS port #0 and #1, and DMRS CDM group #1 contains DMRS port #2 and #3, DMRS CDM group #2 contains DMRS port #4, and #5. For PTRS configuration, as the time domain density is 2, so the PTRS port is located at symbol #4, #6, #8, #12. In FIG. 11a, the PTRS port is associated with DMRS port #0, so the subcarrier of PTRS port is 0 (indexed from 0). In FIG. 11b, there are two DMRS CDM groups. There are two PTRS ports, the time domain location for both PTRS ports are same. The frequency domain position of the first PTRS port is determined by the associated DMRS port #0, so the frequency domain position of PTRS #0 is subcarrier #0. The frequency domain position of the second PTRS port is determined by the associated DMRS port #2, so the frequency domain position of PTRS port #1 is subcarrier #2. FIG. 11c is similar to FIG. 11b, while there is only one PTRS port.

In FIG. 11a, there are two DMRS CDM groups, e.g., DMRS CDM group #0, DMRS CDM group #1 and two TCI states, e.g., TCI state #1, TCI state #2. Both DMRS port #0 and DMRS port #1 of DMRS CDM group #0 are associated with TCI state #1. There is a single PTRS port #0, and it is associated with DMRS port #0, and it is also associated with TCI state #1. DMRS port #2 and DMRS port #3 are associated with TCI state #2. In FIG. 11b, there are two DMRS CDM groups, e.g., DMRS CDM group #0, DMRS CDM group #1 and two TCI states, e.g., TCI state #1, TCI state #2. Besides DMRS port #0 and DMRS port #1 of DMRS CDM group #0 are associated with TCI state #1, there are two PTRS ports, i.e., PTRS port #0 and PTRS port #1, wherein PTRS port #0 is associated with DMRS port #0 and it is also associated with TCI state #1. DMRS port #2 and DMRS port #3 of DMRS CDM group #1 are associated with TCI state #2, PTRS port #1 associated with DMRS port #2, and it is also associated with TCI state #2. In FIG. 11c, there is one DMRS CDM group, e.g., DMRS CDM group #0 and one TCI state, e.g., TCI state #1, and one PTRS port, i.e., PTRS port #0. Both DMRS port #0 and DMRS port #1 of DMRS CDM group #0 are associated with TCI state #1, PTRS port associated with DMRS port #0, and it is also associated with TCI state #1. DMRS port #2 and DMRS port #3 of DMRS CDM group #1 are associated with TCI state #2. There is only one PTRS port, and PTRS port #0 is associated with the lowest indexed DMRS port among two DMRS CDM groups, i.e., DMRS port #0, and the PTRS port #0 is also associated with TCI state #1.

Besides the methods, embodiments of the present application also propose an apparatus of beam indication.

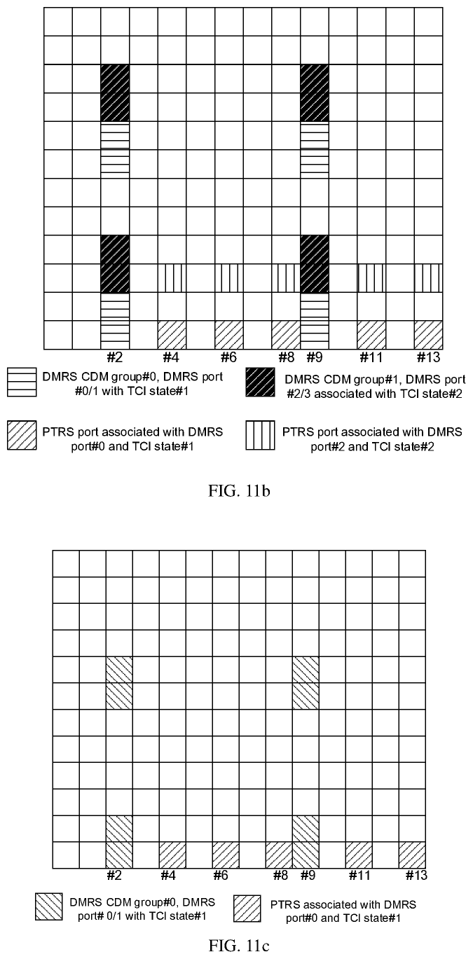

For example, FIG. 12 illustrates a block diagram of an apparatus of beam determination 1200 according to some embodiments of the present application.

As shown in FIG. 12, the apparatus 1200 may include at least one non-transitory computer-readable medium 1201, at least one receiving circuitry 1202, at least one transmitting circuitry 1204, and at least one processor 1206 coupled to the non-transitory computer-readable medium 1201, the receiving circuitry 1202 and the transmitting circuitry 1204. The at least one processor 1206 may be a CPU, a DSP, a microprocessor etc. The apparatus 1200 may be a RAN node, e.g., a gNB or a repeater configured to perform a method illustrated in the above or the like.

Although in this figure, elements such as the at least one processor 1206, transmitting circuitry 1204, and receiving circuitry 1202 are described in the singular, the plural is contemplated unless a limitation to the singular is explicitly stated. In some embodiments of the present application, the receiving circuitry 1202 and the transmitting circuitry 1204 can be combined into a single device, such as a transceiver. In certain embodiments of the present application, the apparatus 1200 may further include an input device, a memory, and/or other components.

In some embodiments of the present application, the non-transitory computer-readable medium 1201 may have stored thereon computer-executable instructions to cause a processor to implement the method with respect to the first RAN node as described above. For example, the computer-executable instructions, when executed, cause the processor 1206 interacting with receiving circuitry 1202 and transmitting circuitry 1204, so as to perform the steps with respect to the first RAN node as depicted above.

In some embodiments of the present application, the non-transitory computer-readable medium 1201 may have stored thereon computer-executable instructions to cause a processor to implement the method with respect to the second RAN node as described above. For example, the computer-executable instructions, when executed, cause the processor 1206 interacting with receiving circuitry 1202 and transmitting circuitry 1204, so as to perform the steps with respect to the second RAN node as illustrated above.

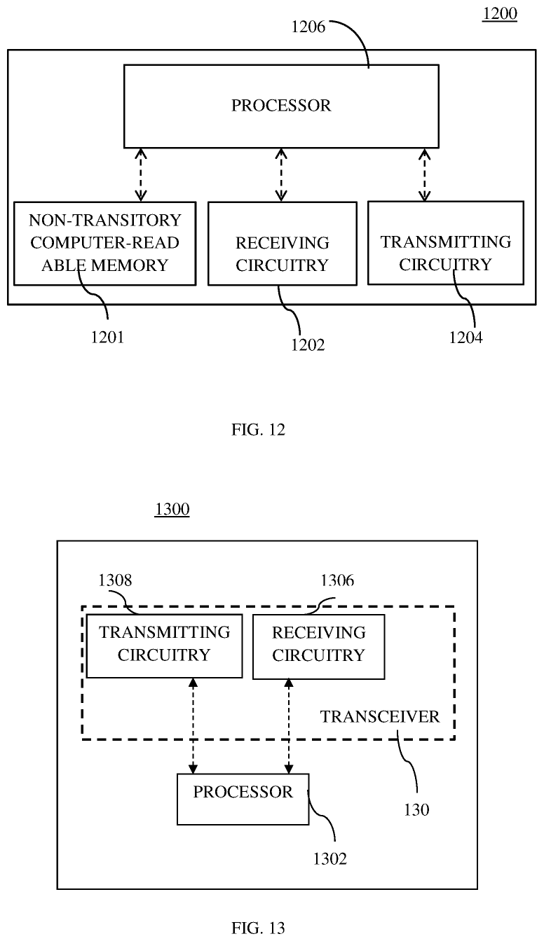

FIG. 13 is a block diagram of an apparatus of beam determination 1300 according to some other embodiments of the present application.

Referring to FIG. 13, the apparatus 1300, for example a gNB or a repeater may include at least one processor 1302 and at least one transceiver 1304 coupled to the at least one processor 1302. The transceiver 1304 may include at least one separate receiving circuitry 1306 and transmitting circuitry 1304, or at least one integrated receiving circuitry 1306 and transmitting circuitry 1304. The at least one processor 1302 may be a CPU, a DSP, a microprocessor etc.

According to some embodiments of the present application, when the apparatus 1300 is a first RAN node, e.g., a repeater, the processor is configured to: receive, via the transceiver, information indicating a set of resource in at least one of time domain or frequency domain associated with a set of TCI state, wherein each TCI state of the set of TCI state is associated at least a part of the set of resource, and perform at least one of uplink transmission or downlink reception in the set of resource associated with the set of TCI state.

According to some other embodiments of the present application, when the apparatus 1300 is a second RAN node, e.g., gNB, the processor may be configured to: transmit information indicating a set of resource in at least one of time domain or frequency domain associated with a set of TCI state, wherein each TCI state of the set of TCI state is associated at least a part of the set of resource, and perform uplink reception or downlink transmission in the set of resource associated with the set of TCI state.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A radio access network (RAN) node, comprising:
at least one memory; and
at least one processor coupled with the at least one memory and configured to cause the RAN to:
receive information indicating a set of resource in at least one of time domain or frequency domain associated with a set of transmission configuration indication (TCI) state, wherein each TCI state of the set of TCI state is associated at least a part of the set of resource, and
perform at least one of uplink transmission or downlink reception in the set of resource associated with the set of TCI state.

2. The RAN node of claim 1, wherein the set of resource is a set of slots and each slot in the set of slot is a downlink slot or uplink slot.

3. The RAN node of claim 2, wherein a mapping between the set of TCI state and the set of slots is configured or predefined, and the mapping is cyclic or sequential.

4. The RAN node of claim 2, wherein a time domain position of the set of slot is configured by a duration in time domain or by a set of slot index.

5. The RAN node of claim 1, wherein the set of resource is a set of frequency domain resource divided into a plurality of physical resource block (PRB) groups by a PRB group size, and each PRB group is associated with a TCI state.

6. The RAN node of claim 5, wherein the set of frequency domain resource is a set of frequency domain resource for a cell or a carrier, and a frequency domain starting position of the set of frequency domain resource is at least one of a frequency domain starting position of the cell, a frequency domain starting position of the carrier, a frequency domain starting position of a lowest indexed bandwidth part (BWP) for the cell or the carrier, or a frequency domain starting position of SSB for the cell or the carrier.

7. The RAN node of claim 5, wherein the set of frequency domain resource is a set of frequency domain resource for a cell or a carrier, and a frequency domain length of the set of frequency domain resource is determined by bandwidth of the cell or the carrier.

8. The RAN node of claim 1, wherein the set of resource is associated with the set of TCI state via at least one pair of values, and for each pair of values, a value corresponds to a frequency domain starting position of at least part of the set of frequency domain resource associated with a TCI state of the at least one TCI states and the other value corresponds to a frequency domain length of the at least part of the set of frequency domain resource.

9. The RAN node of claim 1, wherein subcarrier spacing (SCS) to determine a physical resource block (PRB) of a set of resource in frequency domain is configured, based on a frequency band of a cell or a carrier, based on synchronization signal (SS)/physical broadcast channel (PBCH) block (SSB) for a cell or carrier, based on a lowest indexed bandwidth part (BWP) configuration for a cell or a carrier, or based on SCS of a corresponding BWP associated with the set of resource in frequency domain.

10. The RAN node of claim 1, wherein the set of resource is a set of resource element (RE) of a demodulation reference signal (DMRS) code division multiplexing (CDM) group, and in the case that there are two DMRS CDM groups and two TCI states, REs corresponding to a first one of the two DMRS CDM groups is associated with a first one of the two TCI states, and REs corresponding to a second one of the two DMRS CDM groups is associated with a second one of the two TCI states.

11. The RAN node of claim 10, wherein a time or frequency position of the REs within a physical resource block (PRB) is determined based on a number of additional DMRS, a number of front loaded DMRS symbols, time domain position of the additional DMRS, and a number of DMRS ports.

12. The RAN node of claim 1, wherein the set of resource is a set of resource element (RE) of a phase tracking reference signal (PTRS) port, and in the case that there are two demodulation reference signal (DMRS) code division multiplexing (CDM) groups, two TCI states and two PTRS ports, a first one of the two PTRS ports is associated with a first one of the two TCI states and a lowest indexed DMRS port in a first one of the two DMRS CDM groups, and a second one of the two PTRS ports is associated with a second one of the two TCI states and a lowest indexed DMRS port in a second one of the two DMRS CDM groups.

13. The RAN node of claim 12, wherein REs within a resource block (RB) or RBs of each PTRS port are determined by a number of symbol between adjacent PTRS symbols, a number of RBs between adjacent RBs containing PTRS port, a subcarrier level offset with respect to an associated DMRS port.

14. A radio access network (RAN) node, comprising:
at least one memory; and
at least one processor coupled with the at least one memory and configured to cause the RAN to:
transmit information indicating a set of resource in at least one of time domain or frequency domain associated with a set of transmission configuration indication (TCI) state, wherein each TCI state of the set of TCI state is associated at least a part of the set of resource, and
perform uplink reception or downlink transmission in the set of resource associated with the set of TCI state.

15. A method performed by a radio access network (RAN) node, the method comprising:
receiving information indicating a set of resource in at least one of time domain or frequency domain associated with a set of transmission configuration indication (TCI) state, wherein each TCI state of the set of TCI state is associated at least a part of the set of resource, and
performing at least one of uplink transmission or downlink reception in the set of resource associated with the set of TCI state.

16. The method of claim 15, wherein the set of resource is a set of slots and each slot in the set of slot is a downlink slot or uplink slot.

17. The method of claim 16, wherein a mapping between the set of TCI state and the set of slots is configured or predefined, and the mapping is cyclic or sequential.

18. The method of claim 16, wherein a time domain position of the set of slot is configured by a duration in time domain or by a set of slot index.

19. The method of claim 15, wherein the set of resource is a set of frequency domain resource divided into a plurality of physical resource block (PRB) groups by a PRB group size, and each PRB group is associated with a TCI state.

20. A method performed by a radio access network (RAN) node, the method comprising:
transmitting information indicating a set of resource in at least one of time domain or frequency domain associated with a set of transmission configuration indication (TCI) state, wherein each TCI state of the set of TCI state is associated at least a part of the set of resource, and
performing uplink reception or downlink transmission in the set of resource associated with the set of TCI state.
